(19) United States
(12) Patent Application Publication
(10) Pub. No.: US 2007/0138803 A1
(43) Pub. Date: Jun. 21, 2007

(54) Drive mechanism

(76) Inventors: Dominique Benoit, Bart (FR); Nigel V. Spurr, Solihull (GB); Paul Geoffrey Scott, Solihull (GB)

Correspondence Address: CARLSON, GASKEY & OLDS, P.C., 400 WEST MAPLE ROAD, SUITE 350, BIRMINGHAM, MI, 48009, US

(21) Appl. No.: 11/594,035

(22) Filed: Nov. 7, 2006

(30) Foreign Application Priority Data
Nov. 9, 2005 (GB) 0522794.7

(51) Int. Cl. E05C 3/06

(52) U.S. Cl. 292/201

(57) ABSTRACT

A drive mechanism for a power closure latch includes a latch chassis, a power actuator fixed to the latch chassis, and a resilient member having a base at a first end and a second end that engages a drive member. The base is fixed to the latch chassis, and the drive member is driveable by the power actuator to compress the resilient member. The drive mechanism includes a toggle arm having an input and an output. The input is driveable by the drive member to toggle the output between a first position and a second position. A first end of a second arm has a pivot fixed to the latch chassis and a second end having an input for attachment to the drive member. Driving of the drive member by the power actuator to move the output from the first position to the second position causes compression of the resilient member, and driving of the drive member by the power actuator to move the output from the second position to the first position to deliver an output load for driving an associated power closure latch is assisted by a spring load generated by expansion of the resilient member.

### REFERENCE TO RELATED APPLICATION

This application claims priority to United Kingdom Patent Application GB 0522794.7 filed on Nov. 9, 2005.

### BACKGROUND OF INVENTION

The following invention relates generally to latches, and in particular, but not exclusively, to vehicle door power closure latches.

The refinement of modern passenger vehicle interiors is becoming increasingly important to a vehicle's passengers. Accordingly, manufacturers are placing an increasing importance on the isolation of a passenger cabin from outside environmental factors such as noise, vibration and ambient temperature. In order to isolate a cabin interior from the environmental factors, door seal pressures have increased steadily in recent years.

The increase in door seal pressure has led to conventional manual closing of the door placing an unacceptable load requirement on a door operator. A solution to this problem is to provide a latch that includes a power driven latch bolt which drives the latch from a first safety condition (or an intermediate condition) to a fully closed condition without the need for assistance from the operator.

The term first safety, or intermediate, is used to denote a latch condition achieved when the operator has pushed the door towards the closed position to engage the latch with a door striker, but has not achieved complete closure of the door. In this position, the door is not fully closed, but the door cannot be opened without operating the latch.

In a power closure latch, the power required during a closure stroke (the stroke in which a motor drives the latch both from the intermediate position to the closed position) is greater than the power required during a return stroke (the stroke in which the motor is returned to a rest position in readiness for the next closure of the door). This means that in order to close the latch, the motor must be sufficiently powerful to overcome both the seal load and the friction in the latch mechanism. On the return stroke, the motor only needs to overcome the friction in the latch mechanism. The return stroke therefore requires significantly less power than the power required to overcome the seal load in the closure stroke. The result is that the motor is only using its full power for half of the latch closure/return cycle, and power that is not used is therefore available during the return stroke.

It is known, for example in EP0325464.7 and EP01300813.1, to use the power available during the return stroke to store energy in a spring, and the energy can be released to assist the -motor during the closure stroke.

EP'464 uses a leaf spring mounted on a latch chassis to act on an abutment on a gear wheel. The gear wheel is driven by an electric motor and drives a latch bolt via a series of gears. EP'813 similarly employs a spring (in this case a coil spring) to apply an assistance load to a gear wheel via an output. The gear wheel is driven by an electric motor, and the output acts on the latch bolt to close the latch.

The greatest load reacted by the motor during the closure stroke occurs towards the end of the stroke, where the compression of the seal generates the largest resistance to the closure of the door. In contrast, a spring compressed in the return stroke provides the greatest assistance to the motor at the beginning of the closure stroke when compression of the spring is at its greatest. In the prior art devices cited above, the spring is in its least compressed state towards the end of the closure stroke, and accordingly the load available to assist the motor is at its lowest. The spring assist load and the motor load are therefore poorly matched to provide the most efficient use of the motor power.

It is an object of the current invention to overcome, or at least mitigate, the above problem.

### BRIEF SUMMARY OF INVENTION

The present invention provides a drive mechanism for a power closure latch including a latch chassis, a power actuator fixed to the latch chassis, and a resilient member having a base at a first end and engaging a drive member at a second end. The base is fixed to the latch chassis, and the drive member is driveable by the power actuator to compress the resilient member. A toggle arm has an input and an output. The input is driveable by the drive member to toggle the output between a first position and a second position in a first direction. The power actuator drives the drive member to move the output from the first position to the second position to cause compression of the resilient member in a second direction. Driving of the drive member by the power actuator to move the output from the second position to the first position delivers an output load for driving an associated power closure latch that is assisted by a spring load generated by expansion of the resilient member. The second direction is arranged substantially perpendicular to the first direction to generate a mechanical advantage between the spring load and a spring assist component of the output load.

### DESCRIPTION OF DRAWINGS

The invention will now be disclosed, by way of example only, and with reference to the following drawings, in which:

FIG. 1 is a schematic representation of a mechanism according to the present invention shown in an open or rest position;

FIG. 2 is a schematic representation of the mechanism of FIG. 1 shown in a closed or actuated position;

FIG. 3 is a schematic representation of a second embodiment of mechanism according to the present invention shown in the open or rest position;

FIG. 4 is a schematic representation of the mechanism of FIG. 3 shown in the closed or actuated position; and

FIG. 5 is a chart showing a diagrammatic representation of an assist load of a known power closure latch and the assist load of the present invention, for comparison.

### DETAILED DESCRIPTION OF INVENTION

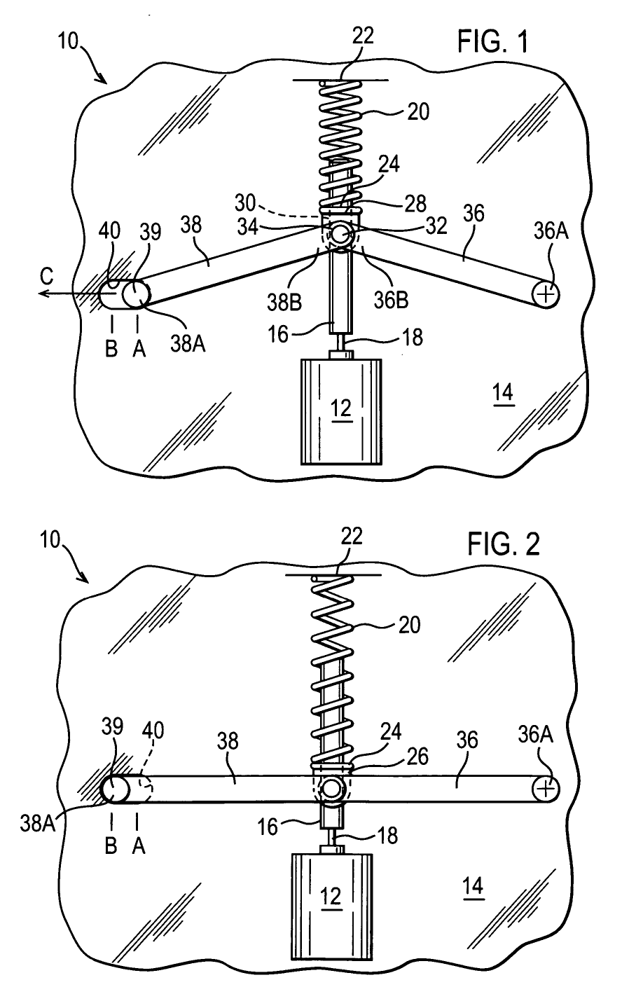

Referring to FIGS. 1 and 2, and in particular FIG. 1, a drive mechanism 10 includes a power actuator in the form of electric motor 12. The electric motor 12 is mounted on a latch chassis 14 to allow a degree of movement between the latch chassis 14 and the electric motor 12, the purpose of which will be described further shortly. Such movement is permitted by mounting the electric motor 12 using bushings (not shown for clarity) or other known deformable systems.

The electric motor 12 drives a screw in the form of an externally threaded rod 16 by way of a shaft 18. While in this embodiment the electric motor 12 directly drives the externally threaded rod 16 by the shaft 18, it is conceivable within the scope of the invention that the externally threaded rod 16 be driven by the electric motor 12 by way of a series of gears or similar drive transferring mechanisms. A resilient member in the form of spring 20 is mounted at an opposite end of the latch chassis 14 to the electric motor 12. A first end or a base 22 of the spring 20 is fixed to the latch chassis 14. A second end 24 of the spring 20 abuts a nut 26. The externally threaded rod 16 acts as a guide for the spring 20 to stabilize the spring 20 in use.

An upper end of the nut 26 defines a spring seat 28 against which the second end 24 of the spring 20 sits. Radially inwardly of the spring seat 28 is a threaded bore 30 which is in threaded engagement with the externally threaded rod 16 (or worm gear). The nut 26 has an outwardly facing surface 32 which defines a pivot 34 which receives a support arm 36 and a toggle arm 38, as will be described in further detail shortly. It is within the scope of the invention that the pivot 34 be arranged to act in a slot in the nut 26. An elongate axis of the slot is arranged at 90 degrees to a compression axis of the spring 20. The pivot 34 is able to move laterally with respect to the nut 26. The purpose of this alternative will be described in further detail shortly. Both forms of the nut 26 make a link joint between the spring 20, the support arm 36 and the toggle arm 38.

The support arm 36 has a first end 36A mounted for rotation on the latch chassis 14. A second end 36B of the support arm 36 is mounted on the pivot 34 for rotation therewith.

A first end 38A of the toggle arm 38 defines an output 39 which is arranged to act in a slot 40. In the embodiments disclosed, the slot 40 is defined by the latch chassis 14. However, it is clearly possible within the scope of the invention that the slot 40 be defined by components other than the latch chassis 14, so long as those components are fixed relative to the latch chassis 14. The second end 38B of the toggle arm 38 is mounted, along with the second end 36B of the support arm 36, on the pivot 34.

In use, the drive mechanism 10 forms part of a power closure vehicle door latch. The output 39 operates a power closure latch bolt (not shown for clarity). The output 39 is capable of moving the latch bolt from a first safety position to a fully closed position and can be arranged either to drive the latch bolt directly or via a mechanism.

Referring now to FIGS. 1 and 2 for comparison, the output 39 of the toggle arm 38 is in a first position A in FIG. 1 and in a second position B in FIG. 2. In toggling between the first position A and the second position B, the output 39 of the toggle arm 38 has moved along the slot 40 in a direction of movement C.

Operation of the latch mechanism is as follows. With the drive mechanism 10 in the position of FIG. 1, the latch (not shown for clarity) is in either an open condition or a first safety position depending on whether the door has been closed by the operator. In the case where the door is open and is then subsequently closed by the operator, the latch will be moved to the first safety condition, with the drive mechanism 10 still in a rest condition as shown in FIG. 1. Upon closure of the door to the first safety condition, a signal is sent to a central control unit (CCU) (not shown for clarity) to instruct the electric motor 12 to close the latch. Upon receipt of the instruction from the CCU, the electric motor 12 turns, which moves the nut 26 down towards the electric motor 12 as shown in FIG. 1 under the assistance of the spring 20. Because the first end 36A of the support arm 36 is fixed for rotation on the latch chassis 14, movement of the nut 26 towards the electric motor 12 causes the output 39 to move along the slot 40 from the first starting point A towards the second position B. The output 39 is thereby able to drive the latch bolt from the first safety position to a closed position to close the latch.

This moves the drive mechanism 10 to the position shown in FIG. 2 where the latch bolt has been driven to the closed position, and the latch is accordingly closed. With the latch in the closed position, the CCU commands the electric motor 12 to stop turning, which leaves the nut 26 arranged directly between the pivoted first end 36A of the support arm and the first end 38A of the toggle arm 38, as shown in FIG. 2.

The electric motor 12 then drives the nut 26 to compress the spring 20 and return the drive mechanism 10 to the rest position (as shown in FIG. 1) ready for the next power closure operation. The nut 26 is retained in that position against the action of the spring 20 by the friction in the mechanism (principally in the electric motor 12).

In this manner, while load is required to compress the spring 20, the load is delivered by the electric motor 12 on the return stroke when the electric motor 12 is not required to drive the latch bolt to close the latch. The energy stored in the compressed spring 20 is then released during the power closure stroke to assist the electric motor 12 in driving the latch bolt.

Because the first end 36A of the support arm 36 and the base 22 of the spring 20 are fixed to the latch chassis 14 and the output 39 acts in the slot 40 defined by the latch chassis 14, it will be necessary for the electric motor 12 to be permitted to move relative to the latch chassis 14 when driving the output 39 between the first position A and the second position B. This relative movement is achieved by the provision of mount bushings (not shown for clarity) because the degree of movement between the electric motor 12 and the latch chassis 14 is minimal. Alternatively, the electric motor 12 is fixed rigidly to the latch chassis 14, and the alternative form of the nut is employed as described above. In the alternative construction, the action of the pivot 34 in the slot 40 accommodates the change in geometry, allowing the electric motor 12 to remain stationary.

The invention provides a distinct advantage over known spring assist latches as follows. As described above, in the drive mechanism 10 of FIG. 1 and 2, the assistance load generated by the spring 20 is geared by way of its transfer to the latch bolt (not shown for clarity) by the output 39 of the toggle arm 38. The prior art devices, however, have a linear relationship between the assistance load generated by the spring and the assistance load transferred to the latch bolt. In contrast with the prior art devices, a spring assistance load generated by the spring 20 gains a mechanical advantage by virtue of the arrangement of the toggle arm 38 and the support arm 36. Likewise, the drive load applied by the electric motor 12 undergoes a similar mechanical advantage to provide the highest load at the end of the closure stroke to match the maximum resistance offered by the seal as it is further compressed towards the closed position.

The drive mechanism 10 is particularly effective with respect to the spring assistance load generated by the spring 20 at its position shown in FIG. 2. The spring assistance load generated by the spring 20 is weakest in this position, but the mechanism generates a higher output assistance load to be delivered to the output 39.

However, as discussed earlier, the highest seal loads are observed at the end of the power closure stroke as the drive mechanism 10 approaches the closed position. The effect of the toggle arm 38 is to generate the highest output assistance load at the output 39 when the drive mechanism 10 is approaching the closed position.

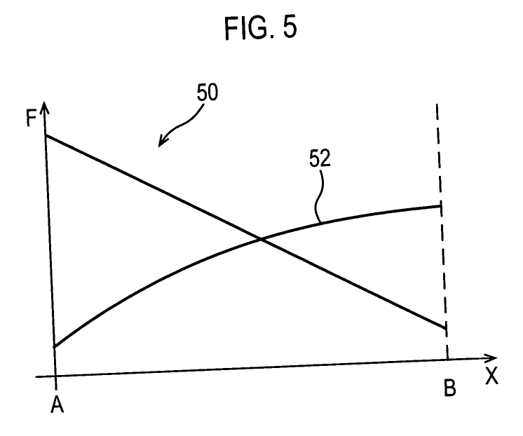

This effect is best observed with reference to the schematic chart shown in FIG. 5. In FIG. 5, the output assistance force generated by the spring 20 as measured at the latch bolt is plotted on the y axis and annotated F, and the extension (that is the distance the free end of the spring has displaced from its compressed position) is depicted on the x axis and annotated X.

When X is equal to zero, the spring 20 of the current invention is in a compressed position, and consequently the output 39 is in the first position A. The first position A is therefore marked on the plot in FIG. 5 where X is equal to zero. When X is at maximum, the spring 20 is in its fully expanded position. Accordingly, the output 39 is in the second position B. The second position B is therefore marked on the x axis of the plot in FIG. 5 at a position where X is at a maximum.

A first plot 50 represents the situation where the free end of a spring acts directly on the latch bolt as observed in prior art devices. The assistance force decreases linearly as the extension of the spring increases.

A second plot 52 represents the output assistance force generated at the output 39 of the toggle arm 38 of the present invention. The action of the toggle arm 38 allows a redistribution of the output assistance force across the extension of the spring 20. In this manner, a relatively high force is generated at the end of extension where the seal load is at its greatest.

Although the first plot 50 and the second plot 52 depicted in FIG. 5 are not to scale, in theory the area under each of the first plot 50 and the second plot 52 will be equal because the energy stored in the spring 20 for a given position of extension will be the same. Accordingly, the toggle mechanism of the current invention provides a redistribution of the release of that energy in the form of an assistance load.

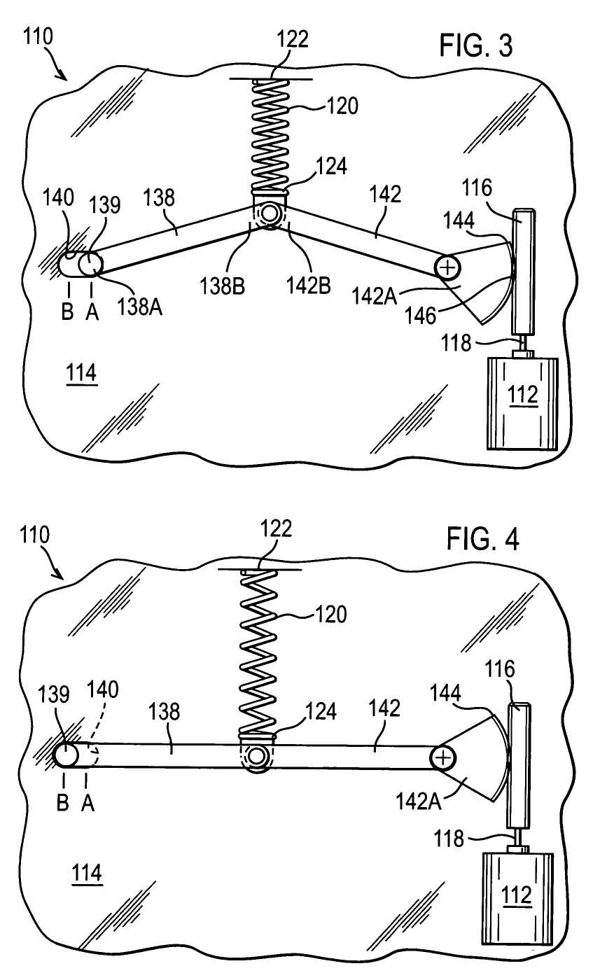

In FIG. 3, a drive mechanism 110 is shown which includes an electric motor 112 fixed on a mechanism chassis 114. The electric motor 112 drives a screw in the form of a worm gear 116 via a shaft 118. A spring 120 is provided having a base 122 which is attached to the mechanism chassis 114. A second end 124 of the spring 120 is received by a nut 126, which differs from the nut 26 of the first embodiment in that the nut 126 does not define a threaded bore. The drive mechanism 110 includes a toggle arm 138 similar to the toggle arm 38 of the first embodiment. An output 139 of the toggle arm 138 acts in a slot 140 and is moveable therealong between a first position A and a second position B. The nut 126 supports a second end 138B of the toggle arm 138 and a second end 142B of a drive arm 142. A first end 142A of the drive arm 142 defines a drive gear 144 having teeth 146 which engage with the worm gear 116.

As shown in a position of FIG. 3, the spring 120 is in a fully compressed state, and the drive mechanism 110 is therefore in a position ready to drive the latch bolt (not shown for clarity) from the first safety position to the closed position.

In the second embodiment, the electric motor 112 acts on the drive arm 142 to move the first end 138A of the toggle arm 138 between the first position A and the second position B instead of acting on the nut 126, as in the first embodiment.

In the drive mechanism 110 of the second embodiment, the electric motor 112 can be fixed to the mechanism chassis 114 without the need to provide relative movement therebetween.

Other than in the differences described above, the embodiment of FIGS. 1 and 2 and the embodiment of FIGS. 3 and 4 operate in a similar way and deliver the advantages of altering the assistance load in a similar way. Consequently, both of the embodiments provide the change in assistance load depicted by the schematic plot of FIG. 5.

The springs 20 and 120 are provided as examples of resilient members. In alternative embodiments of the invention, the springs 20 and 120 could conceivably be replaced with a rubber bushing, gas or air or similar resilient body.

The foregoing description is only exemplary of the principles of the invention. Many modifications and variations are possible in light of the above teachings. It is, therefore, to be understood that within the scope of the appended claims, the invention may be practiced otherwise than using the example embodiments which have been specifically described. For that reason the following claims should be studied to determine the true scope and content of this invention.

1. A drive mechanism for a power closure latch, the drive mechanism comprising:
a latch chassis; a power actuator fixed to the latch chassis-,. a resilient Fneansmember having a first end and a second end, wherein the resilient member has a base at athe first end and engagi a es a drive member at othe second end, the base bei fixed to the latch chassis. and the drive member is driveable by the power actuator to compress the resilient means,member- a toggle arm having Ma togle arm input and aa toggle arm output, wherein the toggle arm input is driveable by the drive member to toggle the toggle arm output between a first position and a second posit osition, and a second arm having a first arm end and a second arm end, wherein a pivot is fixed to the latch chassis at athe first arm end and Ma second arm input is at athe second arm end for attachment to the drive member, inwkhehwherein driving of the drive member by the power actuator to move the toggle arm output from 4sthe first position to 4sthe second position causes compression of the resilient meansmember, and driving of the drive member by the power actuator to move the toggle arm output from 4sthe second position to Lithe first position to deliver an output load for driving an associated power closure latch is assisted by a spring load generated by expansion of the resilient FRefismember.

2. The drive mechanism according to claim 1 wherein the drive member is a nut dr iven by a screw rotated by the power actuator.

3. The drive mechanism according to claim 2 wherein the nut definesl a link joint between the toggle arm input, the second arm input, and the resilient fneansmember.

4. The drive mechanism according to claim 3 wherein the second arm is a support arm for preventing the drive member from deflecting under the output load.
Serial No. 11/594,035 60130-2748 PUS1 5. (CURRENTLY AMENDED) The drive mechanism according to claim 4 wherein the power actuator eraf epincludes an electric motor arranged to have 4san axis of rotation coexistent with a compression/extension axis of the resilient fneasmember.

6. The drive mechanism according to claim 5 wherein the electric motor is mounted on a moveable joint.

7. The drive mechanism according to claim 1 wherein the toggle arm input is driveable in a first direction by the drive member to toggle the toggle arm output between the first position and the second posi+io position, and Xcompression of the resilient neansmember is achieved in a second direction, the second direction being arranged substantially perpendicular to the first direction so as to generate a mechanical advantage between the spring load and a spring load component of the output load.

8. The drive mechanism according to claim 1 wherein the second arm is a drive arm having and the first arm end is pivoted on the latch chassis, and athe togle arm input is at athe second arm end asehiehand is connected to the drive member.

9. The drive mechanism according to claim 7 wherein the drive arm4furter includes a gear portion.

10. The drive mechanism according to claim 8 wherein the power actuator drives a worm gear which in turn drives Wa gear portion of the drive arm.

11. The drive mechanism according to claim 1 wherein the resilient Rismember is a coil spring.
Serial No. 11/594,035 60130-2748 PUSI 12. (CURRENTLY AMENDED) A drive mechanism for a power closure latch, the drive mechanism comprising:- a latch chassis-,* a power actuator fixed to the latch chassis-, a resilient FDasmember having a first end and a second end, the resilient member having a base at athe first end and ae a drive member at a second end, the base isegs fixed to the latch chassisI and the drive member beis driveable by the power actuator to compress the resilient m member; and a toggle arm having an input and an output, wherein the input is driveable in a first direction by the drive member to toggle the output between a first position and a second positisposition, wherein driving of the drive member by the power actuator to move the output from isthe first position to Lthe second position causes compression of the resilient feansmember in a second direction, and wherein driving of the drive member by the power actuator to move the output from Lthe second position to 4sthe first position to deliver an output load for driving an aeecated-the power closure latch is assisted by a spring load generated by expansion of the resilient rneasmember, and wherein the second direction is arranged substantially perpendicular to the first directions as to generate a mechanical advantage between the spring load and a spring load component of the output load.

13. A power closure latch having theThe drive mechanism according to ]la im 1 wherein the toggle arm output drives a latch bolt to move the latch bolt from a first safety position to a closed position where the latch bolt retains an associated striker to maintain the power closure latch in a chosen condition.

14. A power closure latch having theThe drive mechanism according to Claimclaim 12 wherein the toggle arm output drives a latch bolt to move the latch bolt from a first safety position to a closed position where the latch bolt retains an associated striker to maintain the power closure latch in a chosen condition.
